(19) United States
(12) Patent Application Publication
(10) Pub. No.: US 2022/0349481 A1
(43) Pub. Date: Nov. 3, 2022

(54) Globe Valve

(71) Applicant: Electricite de France, Paris (FR)

(72) Inventor: Jérôme Ferrari, Bois Le Roi (FR)

(73) Assignee: Electricite de France, Paris (FR)

(21) Appl. No.: 17/621,522

(22) PCT Filed: Jun. 23, 2020
(86) PCT No.: PCT/EP2020/067472

§ 371 Date: Dec. 21, 2021

(30) Foreign Application Priority Data
Jun. 24, 2019 (FR) FR1906817

(51) Int. Cl. F16K 3/02; F16K 3/314; F16K 3/24; F16K 27/04

(52) U.S. Cl. CPC F16K 3/0209; F16K 3/314; F16K 3/246; F16K 27/041

(57) ABSTRACT

A globe valve, having a body through which a fluid circulation duct passes, the latter delimiting a fluid path with an inlet and an outlet, and a shutoff member housed inside a branch generally perpendicular to the body, this shutoff member being movable between a first end position, in which it shuts off the duct, and a second end position, in which it does not shut off the duct, wherein the duct has, on either side of the region of action of the shutoff member, a generally circular liquid circulation section, which is connected continuously, at least in the region of action of the shutoff member, to a section that is longer than it is wide, the body (2) not having an element that protrudes towards the inside of the duct.

### FIELD OF THE INVENTION

The present invention lies in the field of plumbing and more particularly relates to a globe valve.

It finds application in particular in the industrial fields of electricity production (of nuclear origin, fossil origin, etc.), chemistry, petroleum, etc.

### TECHNOLOGICAL BACKGROUND OF THE INVENTION

Globe valves are widely used in industry due to their robustness. However, in the current state of the art, the use of these valves generates significant pressure losses. This, consequently, with regard to the flow rate which must be passed through the distribution lines, makes it necessary to over-dimension the valves, the actuators or even the lines themselves. This increases costs and reduces resistance to earthquakes.

Within such valves, the globe (or flap, also called shutter) moves perpendicularly to the fluid path and perpendicularly to its sealing seat. The shutter can be in the closed position, in the fully open position or in any intermediate position.

These valves have a mounting direction and their closing is generally in countercurrent to the direction of circulation of the fluid. On opening, the fluid pressure then facilitates the operation.

For small diameters, the flap often takes the shape of a needle. For accurate adjustments, it sometimes looks like a needle.

But these globe valves, whose body is cast or forged, have the characteristic of presenting fluid circulation paths (abbreviated “fluid path”) of tortured shape, with bends and contractions in the passage between the shutter and the seat which generate large pressure losses.

They are widely used in industry for their “robustness”. They open with a short stroke of the stem, which allows the use of a bellow that ensures the sealing between the fluid and the outside. Their actuation induces little friction on their sealing surfaces. They have very slender profiles which provide some earthquake sensitivity, which is increased in case of use of an actuator which will add significant mass at the top of the building.

For larger flow rates requiring larger nominal diameters, other valve technologies are preferred, such as, for example, ball valves or gate valves. One of the reasons for this choice is that the globe valves of larger dimension (>DN 80) are sensitive to earthquakes.

The ball valves consist of a body and a shutter called a “rotating” shutter which moves along a rotational movement perpendicular to the direction of circulation of the fluid.

As to the gate valves, they include a shutter which moves perpendicularly to the fluid path and parallel to the sealing seats.

When the manufacturers need to limit the pressure losses, they usually have recourse to such devices. But these valves have their own drawbacks. For example, ball or cylindrical valves are sensitive to the particles present in the fluid, which can scratch the sealing surfaces, while the gate valves generate significant friction between the sealing surfaces of the shutter and the seat of this shutter.

It is also possible to reduce the pressure losses while maintaining a technology close to that of the conventional globe valve. Thus, it is sometimes proposed to place a globe valve at the level of a circulation elbow of the fluid path, which already significantly reduces pressure losses.

There is also a “Y” globe valve technology whose purpose is specifically to reduce pressure losses. This technology is hardly used in French nuclear power plants, perhaps for reasons of design difficulties.

In addition, all of the solutions listed above consist of replacing the whole valve.

Another prior art known to the applicant consists of the following documents: FI 20049, CH 197 056, U.S. Pat. No. 3,648,718, US 2007/227600, WO2012/168939 and U.S. Pat. No. 2,685,426.

The present invention aims to reduce the pressure losses of the globe valves, at constant valve size.

### SUMMARY OF THE INVENTION

Thus, the present invention relates to a globe valve, which includes a body through which a fluid circulation channel passes, which delimits a fluid path with an inlet and an outlet, as well as a shutter housed inside a branch generally perpendicular to said body, this shutter being movable between a first extreme position in which it obturates said channel and a second extreme position in which it does not obdurate the channel, characterized by the fact that said channel has, on either side of the region of action of said shutter, a generally circular liquid circulation section, which is connected continuously, at least in the region of action of said shutter, to a section that is longer than it is wide, that is to say flattened, said body being devoid of any element protruding inwardly of said channel.

The expression “the body being devoid of any element protruding inwardly of said channel”, according to the present invention, means when the shutter is housed inside said body. Expressed differently, this expression is understood when the liquid is circulating in the valve that is to say when the latter is equipped with a shutter with its seat and its cage.

Thanks to the invention, a significant reduction in the pressure losses is achieved by making at least modifications to the body of the valve only, that is to say without having to systematically modify the other parts that compose it (stem and shutter in particular).

According to other non-limiting and advantageous characteristics of the invention:
said channel has an upward slope in the region of action of said shutter;
said channel has a first inflection upstream of the upward slope area and a second inflection downstream of the upward slope area, the terms “upstream” and “downstream” being considered by taking into account the direction of flow of a fluid;
said shutter has a spout-shaped, that is to say generally beveled, free end so as to ensure the continuity of the wall of the channel in the fluid circulation position;
it has an annular-shaped seat whose central aperture is intended to be crossed by said fluid path;
it includes a cage for guiding said shutter and holding its seat and in that this cage has an annular shape, whose wall has a circulation passage of the fluid path which has a shape and an orientation similar to those of said section that is longer than it is wide;
said seat and said cage are removable;
said seat and said cage are irremovable.

### BRIEF DESCRIPTION OF THE DRAWINGS

Other characteristics and advantages of the invention will become apparent upon reading the following description of a preferred embodiment of the invention. This description is made with reference to the appended drawings in which:

FIG. 1 is a longitudinal sectional view of a globe valve in accordance with the state of the art, which represents in chain dotted lines the theoretical shape of an ideal fluid path, that is to say causing low pressure loss;

FIG. 2 is a longitudinal sectional view of a valve body in accordance with the present invention;

FIG. 3 is a view similar to FIG. 2, the direction of observation being different;

FIG. 4 is also a view similar to FIG. 3, along a direction different from the two previous ones;

FIG. 5 is a three-dimensional representation, derived from modeling software, of the fluid path obtained using a valve according to the present invention;

FIG. 6 is also a representation of the fluid path, on which a seat and a cage equipping the valve also appear;

FIG. 7 is a perspective view of the aforementioned seat;

FIG. 8 is a perspective view of the aforementioned cage;

FIG. 9 is a longitudinal sectional view of a valve body according to the invention, which also and partially shows its shutter in the open position, that is to say allowing the flow of fluid;

FIG. 10 is a view similar to FIG. 9, the shutter being represented in the closed position, that is to say opposing the flow of fluid.

### DETAILED DESCRIPTION OF THE INVENTION

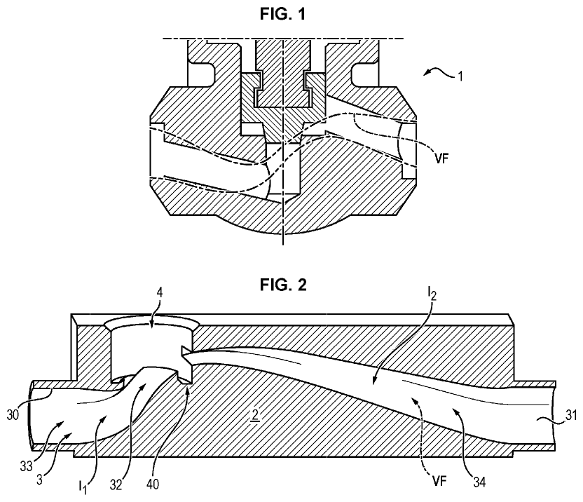

In the appended FIG. 1, the general structure of a globe valve 1 in accordance with the state of the art is recognized. The ideal fluid path VF to be obtained thanks to the valve according to the invention is also represented superimposed and delimited by chain dotted lines.

It is meant by the expression “fluid path” throughout the present description, the volume delimited by the fluid which is intended to circulate through the valve.

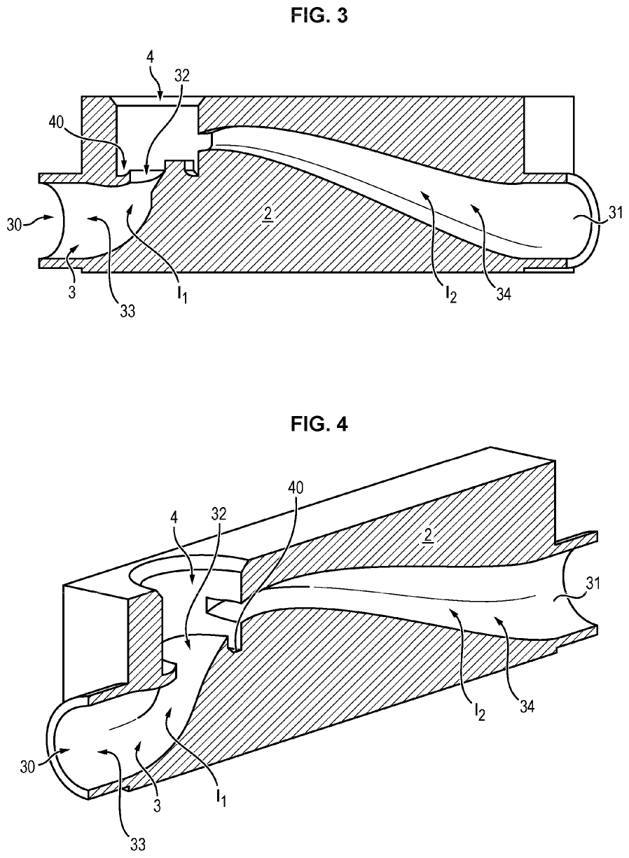

FIG. 2 represents at least in part the body 2 of a valve 1 according to the invention.

This body is crossed by a fluid circulation channel 3 which delimits the aforementioned fluid path VF. The inlet and outlet of this channel are referenced respectively 30 and 31.

The body 2 also includes a second cylindrical channel 4, hereinafter referred to as “branch” 4, which extends along a direction generally perpendicular to the channel 3.

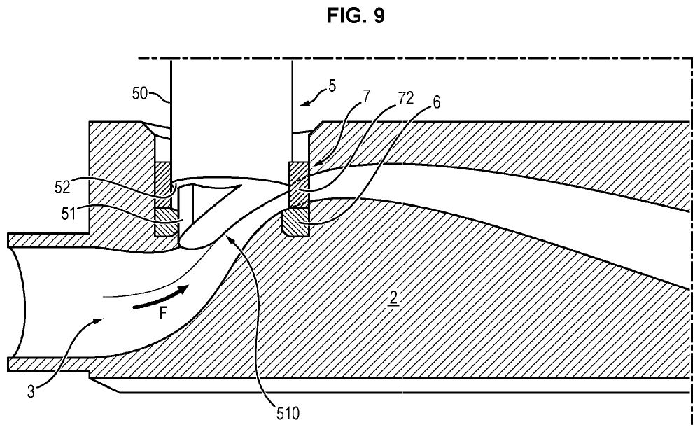

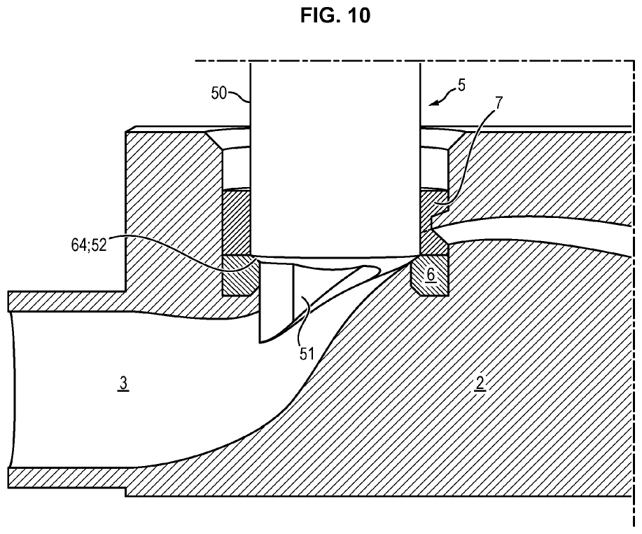

The branch 4 is intended to receive the shutter of the valve, as can be seen in FIGS. 9 and 10.

As clearly visible in FIGS. 2 to 4, the branch 4 extends until interfering with the channel 3 and has an annular bottom 40 which encircles, that is to say surrounds the corresponding region of the channel 3.

The present Applicant has observed that this channel 3, insofar as it has, on either side of the region of action of the shutter, a generally circular liquid circulation section, which connects gradually, at least in the region of action of said shutter, to a section that is longer than it is wide, that is to say “flattened” (for example oblong or elliptical), the largest dimension of this section extending substantially perpendicularly to the axis of the channel 4, and that the body 2 is devoid of any element protruding inwardly of the channel 3, then the pressure losses of such a valve are drastically reduced.

Of course, within the meaning of the present application, it is meant by the expression “region of action of the shutter” the area 32 of the channel 3 which interferes with the branch 4.

In FIGS. 2 to 4, the areas of the channel 3 in which the latter has a generally circular section are referenced 33 and 34.

The channel 3 has an upward slope in the region of action of said shutter that is to say in the area 32. They are also so due to the fact that the channel has a first inflection upstream 2 0 of the upward slope area 32 and a second inflection downstream of the downward slope area 32, the terms “upstream” and “downstream” being considered by taking into account the direction of flow of a fluid.

Expressed otherwise, the valve according to the invention is particularly optimized in terms of pressure losses, as soon as the fluid path VF benefits from:
An inclined passage in line with the shutter;
Bends allowing bringing the fluid from the inlet to this passage by inclining it correctly;
Bends allowing bringing the fluid from the inclined passage towards the outlet oriented in a generally horizontal manner;
From a contraction aiming to deform the fluid path from a circular shape at the inlet to the shape of the passage;
An expansion aiming to reform the circular shape of the circular and generally horizontal outlet.

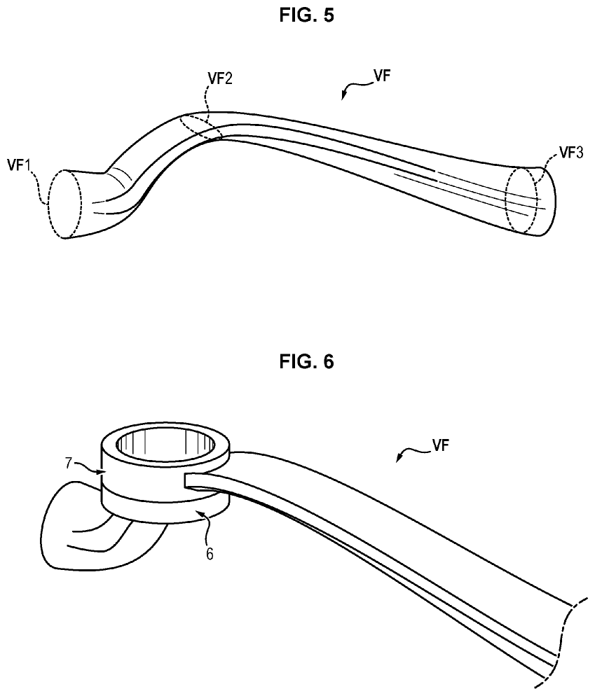

FIG. 5 represents, derived from modeling software, the fluid path VF obtained using the valve according to the present invention. The references VF1 and VF3 identify the circular sections of the path, while the reference VF2 identifies the “flattened” section of the path.

FIGS. 6 and following give more detail on the structure of the valve according to the invention.

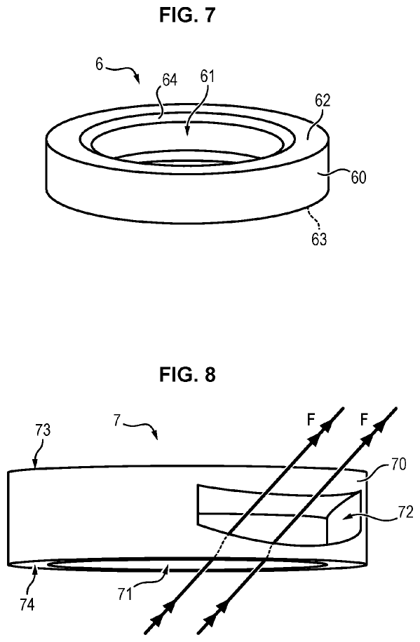

As shown particularly in FIGS. 7 and 9, the valve body 2 is equipped with a ring-shaped seat 6. By way of example, such a seat is made of a material such as stainless steel. This seat is dimensioned so that it can be positioned in the aforementioned annular bottom 40 of the branch 4, while guaranteeing a perfect sealing.

The opposite faces 62 and 63 of the body 60 of this seat are planar and parallel. However, as regards the upper face 62, it can be observed that it extends in the direction of the central aperture 61, by a beveled peripheral flank 64 forming a sealing surface (as will be seen below). Of course, other shapes can be envisaged.

This seat 6 is advantageously removable, but it is also conceivable that it is permanently attached to the body 2.

A cage 7 which has an annular shape like the seat 6, rises above the latter. Its external diameter is strictly identical to that of the seat 6 and its upper and lower faces 73 and 74 are planar and parallel. Its internal diameter is, for its part, dimensioned so that it coincides (that is to say is aligned) with the emergence of the beveled flank 64 of the seat 6. In one embodiment, not represented, the external diameters above are not identical.

As particularly seen in FIG. 8, its wall has a through-passage (opening) 72 which has a shape similar, and if possible identical, to that of the “flattened” shape of the channel 3 and of the fluid path VF. This passage 72 therefore communicates its central aperture 71 with the outside. The interest of this structure will be understood later.

Again with reference to FIG. 9, the presence of the body 50 of the shutter 5 of the valve is noted. This shutter has not been represented in whole. Indeed, for a better reading of the figure, simply its lower portion cooperating with the channel 3 has been represented.

This cylindrical-shaped body 50 has a diameter, apart from the clearance, identical to the internal diameter of the cage 70.

Preferably (although this is not mandatory), the body 50 is extended by a spout 51 which is part of a cylinder of diameter smaller than that of the body 50. The annular shoulder 52 which separates them is also beveled and constitutes a second sealing surface, as will be explained below.

Finally, the free end 510 of the spout 51 is beveled and is shaped so as to match, as much as possible, the curvature of the channel 3 in this region of the valve 1.

In FIG. 9, the shutter 5 is represented in a position which authorizes the passage of fluid in the channel 3. The spout 51 is partially engaged in the seat 6. Thus, the fluid F (see arrows in FIGS. 8 and 9) which flows through the valve “slides” without being disturbed in its stream along the end 510 of the spout 51, passes through the central aperture 61 of the seat then that 71 of the cage 7, to finally escape through the passage 72. Again, it is not disturbed in its stream, because the passage 72 has a shape similar and preferably identical, to the section of the channel 3 in this region.

This is symbolically illustrated by the diagram in FIG. 6.

When the valve is closed, which corresponds to the situation of FIG. 10, the shutter 5 is moved downwards, until the sealing surfaces 52 of the body 50 and 64 of the seat 6 are in contact. In such a position, the passage 61 of the seat 6 is closed, so that the passage of fluid is impossible.

In another version of the present valve, a shutter 5 devoid of spout 51 can be used.

To limit the space requirement, it is possible to abruptly shorten the diffuser portion of such a valve.

All industries using valves may be interested in that of the invention (nuclear power, petroleum, chemistry, etc.).

The invention reduces the required valve size, which reduces all associated costs: actuators, pipes, support, required space, maintenance, etc. In addition, due to its reduced size, such a valve more easily retains its operability, even after an earthquake has occurred.

The reduction in the pressure losses proposed here is done by reducing to the maximum the disturbances made to the flow.

In any event, according to the present invention, due to the sharp drop in the pressure losses, the initial flow rate of the valve is maintained, despite the smaller passage section.

Such valves can therefore be of smaller size, for the same nominal flow rate.

1. A globe valve, which includes a body through which a fluid circulation channel passes, which delimits a fluid path with an inlet and an outlet, as well as a shutter housed inside a branch generally perpendicular to said body, this said shutter being movable between a first extreme position in which it obturates said fluid circulation channel and a second extreme position in which it does not obturate said fluid circulation channel, wherein said fluid circulation channel has, on either side of a region of action of said shutter, a generally circular liquid circulation section, which is connected continuously, at least in said region of action of said shutter, to a section that is longer than it is wide, that is to say flattened, said body being devoid of any element protruding inwardly of said fluid circulation channel.

2. The valve according to claim 1, wherein said channel has an upward slope in said region of action of said shutter.

3. The valve according to claim 2, wherein said fluid circulation channel has a first inflection upstream of said upward slope and a second inflection downstream of said upward slope, the terms “upstream” and “downstream” being considered by taking into account the direction of flow of a fluid.

4. The valve according to claim 1, wherein said shutter has a spout-shaped, that is to say generally beveled, free end so as to ensure the continuity of a wall of said fluid circulation channel in a fluid circulation position.

5. The valve according to claim 1, wherein said valve has an annular-shaped seat whose central aperture is intended to be crossed by said fluid path.

6. The valve according to claim 5, wherein said valve includes a cage for guiding said shutter and holding said seat and wherein cage has an annular shape, whose wall has a circulation passage of the fluid path which has a shape and an orientation similar to those of said section that is longer than it is wide, that is to say flattened.

7. The valve according to claim 5, wherein said seat and said cage are removable.

8. The valve according to claim 5, wherein said seat and said cage are irremovable.
